(19) United States
(12) Patent Application Publication
(10) Pub. No.: US 2023/0213398 A1
(43) Pub. Date: Jul. 6, 2023

(54) AN OPTICAL ELEMENT FOR SENSING A CHANGE IN STRAIN

(71) Applicant: ARKWRIGHT TECHNOLOGIES PTY LTD, Coromandel Valley (AU)

(72) Inventor: John ARKWRIGHT, Coromandel Valley (AU)

(73) Assignee: ARKWRIGHT TECHNOLOGIES PTY LTD, Coromandel Valley (AU)

(21) Appl. No.: 17/998,222

(22) PCT Filed: May 6, 2021
(86) PCT No.: PCT/AU2021/050419

§ 371 Date: Nov. 8, 2022

(30) Foreign Application Priority Data
May 8, 2020 (AU) 2020901482

(51) Int. Cl. G01L 1/24; G02B 6/124; G02B 6/38

(52) U.S. Cl. CPC G01L 1/246; G02B 6/124; G02B 6/38

(57) ABSTRACT

The present disclosure discloses an optical element for measuring a change in strain. The optical element has ends and first and second portions for guiding light which extend between the ends of the optical element and are mechanically coupled to each other at at least one position. Each of the first and second portions for guiding light comprise at least one Bragg grating. The optical element is arranged such that, when an axial or uniaxial strain is equally applied to the first and second portions for guiding light at the ends of the optical element, an optical response from the at least one Bragg grating of the first portion for guiding light differs from an optical response form the at least one Bragg grating of the second portion for guiding light.

### FIELD OF THE INVENTION

The present invention broadly relates to an optical element and a system for sensing a change in strain.

### BACKGROUND OF THE INVENTION

Optical devices for sensing a change in applied strain are now being developed. These optical devices may comprise an optical fibre Bragg grating, which has an optical response to light guided to the Bragg grating. The optical response depends on strain experienced by the Bragg grating. Optical sensing devices including such Bragg gratings have the advantage that they are usually smaller than comparable electrical or mechanical sensing devices.

Bragg gratings are strain and temperature sensitive fibre optic components. A drawback is their cross sensitivity between temperature and strain, which requires knowledge of the sensing environment or a means of compensating for the unwanted parameter, e.g. when measuring strain, and variation in temperature will be manifest as an apparent change in measured strain, and similarly when measuring temperature, any change in strain on the fibre will cause an apparent change in measured temperature.

It is possible to compensate for such cross sensitivity for example by having a second fibre Bragg grating located close to a primary sensing fibre Bragg grating but packaged so that the second fibre Bragg grating only responds to a change in temperature. An example of this would be to have a fibre Bragg grating strain gauge bonded to a work piece, with the second fibre Bragg grating loosely located in a capillary tube close to the primary strain sensing fibre Bragg grating. However, such known arrangements have the disadvantage of lacking stability and robustness.

### SUMMARY OF THE INVENTION

The present invention provides in a first aspect an optical element for measuring a change in strain, the optical element having ends and having first and second portions for guiding light, the first and second portions extending between the ends of the optical element and being mechanically coupled to each other at at least one position, each of the first and second portions for guiding light comprising at least one Bragg grating;

wherein the optical element is arranged such that, when an axial or uniaxial strain is equally applied to the first and second portions for guiding light at the ends of the optical element, an optical response from the at least one Bragg grating of the first portion for guiding light differs from an optical response form the at least one Bragg grating of the second portion for guiding light.

When a Bragg grating is exposed to a change in ambient temperature, the Bragg grating will experience a change in refractive index and consequently there will be a change in optical response by the Bragg grating. The optical element typically is arranged such that a difference in optical response between the Bragg gratings of the first portion for guiding light and the second portion for guiding light is at least largely independent from a change in the ambient temperature.

As the difference in optical response between the Bragg gratings of the first portion for guiding light and the second portion for guiding light is at least largely independent from an ambient temperature or a change in ambient temperature, it is possible to determine an applied axial strain in a manner that is independent of a change in ambient temperature.

The first and second portions for guiding light may be directly or indirectly mechanically coupled to each other. In one embodiment the first and second portions for guiding light are coupled to each other at one or more positions along a length between the ends of the optical element. Alternatively, the first and second portions for guiding light may be directly or indirectly mechanically coupled at ends of the optical element only. In a further alternative the first and second portions for guiding light may be indirectly coupled along some, the majority or the entire length of the optical element using an elastic material.

The optical element typically is structured such that a change in axial or uniaxial strain to which the optical element is exposed is experienced by the first portion for light guiding (which may be for example a straight portion and/or may be oriented along an axis of the optical element), but is not experienced, or to a lesser degree experienced, by the second portion for light guiding.

In one embodiment the first portion for guiding light is a first optical fibre portion and the second portion for guiding light is a second optical fibre portion. The first and second optical fibre portions may be portions of one continuous optical fibre or may be portions of respective optical fibres.

The first and second optical fibre portions may have different materials properties and/or different geometrical arrangements.

The difference in optical response between the Bragg gratings of the first and second portions for guiding light may be a consequence of differences in materials properties such as differences in refractive indices, elasticities or plasticities of at least portions of the first and second portions for guiding light.

Alternatively or additionally, the first and second portions for guiding light may be positioned to guide light along paths having respective shapes. For example, the first optical fibre portion may be oriented along an axis of the optical element (and may be nominally straight) and the second optical fibre portion may be wound around the first optical fibre portion such as in a substantially helical manner. Further, the second optical fibre portion may be curved or form an undulating shape in a plane and may by oriented along for example a sinusoidal-like path. The first and second optical fibre portions typically are attached to each other at various positions and attachment may be effected using a suitable adhesive.

In one embodiment the first portion for guiding light is directly or indirectly mechanically coupled to an object. The first portion for guiding light may be mechanically coupled to the object along at least a majority of a length of the first portion for guiding light between the ends of the optical element. The second portion for guiding light may not be directly mechanically coupled to the object.

In an alternative embodiment the second portion for guiding light is mechanically coupled to the object along some or at least a majority of a length of the second portion for guiding light. The at least one Brag grating of the first portion for guiding light and the at least one Bragg grating of the second portion for guiding light may have respective angular orientations relative to an axis of the optical element. The at least one Bragg grating of the first portion for guiding light may in this embodiment be orientated substantially parallel to an axis of the optical element and the at least one Bragg grating of the second portion for guiding light may be oriented at a transversal orientation relative to the axis of the optical element.

The first optical fibre portion may also be oriented along an axis of the optical element and the second optical fibre portion may be wound around the first optical fibre portion such as in a substantially helical manner, wherein the first and second optical fibre portions are attached to each other at various positions.

In an alternative embodiment the first and second portions for guiding light are respective cores of a multi-core optical fibre. The cores of the multi-core optical fibre are attached to each other by cladding of the multi-core optical fibre. For example, the multi-core optical fibre may comprise a first and second core forming the first and second portions for guiding light. The first and second cores of the multi-core optical fibre may comprise respective materials and the differences in optical response by the Bragg gratings may be a consequence of differences in stress optic coefficients of the first and second cores. Alternatively or additionally, the first and second cores may have respective geometrical arrangements within the multi-core optical fibre. For example, the first core may be oriented along an axis of the optical element (and may be nominally straight) and the second core may be wound around the first core such as in a substantially helical manner. Further, the second core may for example be curved or form an undulating shape in a plane and may by oriented along for example a sinusoidal-like path.

Each of the first and second portions for guiding light may comprise a series of Bragg gratings.

The present invention provides in a second aspect a system for measuring a change in strain, the system comprising:

the optical element in accordance with the first aspect of the present invention;

an optical circulator having at least three ports;

a light source optically coupled to a first port of the optical circulator;

the first portion for guiding light of the optical element being optically coupled to a second port of the optical circulator and the first and second portion for guiding light being optically coupled in series; and

a detector being optically coupled to a third port of the optical circulator;

wherein the first and second portions are portions of a single optical fibre that is coupled at one end to the optical circulator and forms a loop such that both the first and second portions for guiding light are positioned in close proximity to each other.

The light source may in one embodiment be aa low coherence and may be a broadband light source. Alternatively, the light source may in other embodiments arranged for emission of light within a narrow wavelength range. In one embodiment the optical sensing element is arranged such that light guided through the first and second portions for guiding light is propagating through the first portion for guiding light before being guided through the second portion for guiding light. When the at least one Bragg grating of the first portion for guiding light and the at least one Bragg grating of the second portion for guiding light have the same optical properties and no axial or uniaxial strain is applied the optical element, the Bragg grating of the first portion for guiding light will generate an optical response (reflect light) at a specific wavelength of light guided to that Bragg grating and the Bragg grating of the second portion for guiding light will not generate a response at that specific wavelength (assuming that 100% of light at the specific wavelength is being reflected by the Bragg grating of the first portion for guiding light).

Alternatively, when an axial or uniaxial strain is applied the optical element, the at least one Bragg grating of the first portion for guiding light will generate an optical response (reflect light) at a specific wavelength of light guided to that Bragg grating and the Bragg grating of the second portion for guiding light will also generate a response, but at a (slightly) different wavelength as the optical element is arranged such that an optical response from the at least one Bragg grating of the first portion differs from a corresponding optical response form the at least one Bragg grating when an axial or uniaxial strain is applied to the optical element. The system for sensing a change in strain provides the advantage that a change in strain can be detected by detecting a change in total intensity of the light responses received from both the first and second portions for guiding light. There is consequently no need for a complex and expensive spectrometer, and the light detector may be a relatively simple and inexpensive light intensity detector, which may comprise a photodiode for example.

The present invention provides in a third aspect a system for measuring a change in strain, the system comprising:

the optical element in accordance with the first aspect of the present invention;

an optical circulator having at least four ports;

a light source optically coupled to a first port of the optical circulator;

the first portion for guiding light of the optical element being optically coupled to a second port of the optical circulator;

the second portion for guiding light of the optical element being optically coupled to a third port of the optical circulator; and

a detector being optically coupled to the fourth port of the optical circulator;

wherein the first and second portions for guiding light are portions of respective optical fibres.

The light source typically is a low coherence and broadband light source. When the at least one Bragg grating of the first portion for guiding light and the at least one Bragg grating of the at least one second portion for guiding light have the same optical properties and no axial or uniaxial strain is applied the optical element, the at least one Bragg grating of the first portion for guiding light will generate an optical response (reflect light) at a specific wavelength and that response is then directed by the optical circulator to the at least one Bragg grating of the second portion for guiding light where it is reflected before being directed by the optical circulator to the detector.

Alternatively, when the at least one Bragg grating of the first portion for guiding light and the at least one Bragg grating of the second portion for guiding light have the same optical properties and an axial or uniaxial strain is applied to the optical element, such that differing strains are felt by the Bragg gratings in each portion, the at least one Bragg grating of the first portion for guiding light will generate an optical response (reflect light) at a specific wavelength of light guided to that Bragg grating and the Bragg grating of the second portion for guiding light will, when the response from the at least one Bragg grating of the first portion for guiding light is directed by the optical circulator to the at least one Bragg grating of second portion for guiding light, reflect only a portion of the response from the at least one Bragg grating of the first portion for guiding light as the optical element is arranged such that an optical response from the at least one Bragg grating of the first portion differs from a corresponding optical response from the at least one Bragg grating when an axial or uniaxial strain is applied to the optical element. Similar to the system for sensing a change in strain in accordance with the second aspect of the present invention, the optical sensing system consequently provides the advantage that a change in strain can be detected by detecting a change in total intensity of the light received by the detector, which may be a relatively simple and inexpensive light intensity detector, which may comprise a photodiode for example. It will be clear to a person skilled in the art however, that the optical element may also be monitored using conventional spectroscopic methods or, in the case of the 4 port circulator design, by tuneable laser and detector.

The present invention provides in a fourth aspect a system for measuring a change in strain, the system comprising:

the optical element in accordance with the first aspect of the present invention;

an optical spectral interrogator, comprising a light source, a detector or detectors, and at least one independent optical input;

the first portion for guiding light of the optical element being optically coupled to one input port of the optical interrogator;

the second portion for guiding light of the optical element being optically coupled to a second input port of the optical interrogator;

wherein the first and second portions for guiding light are portions of the respective optical fibres.

The invention will be more fully understood from the following description of specific embodiments of the invention. The description is provided with reference to the accompanying drawings.

### BRIEF DESCRIPTION OF THE DRAWINGS

FIG. 1 (a) to (c) illustrate a system for measuring a change in strain in accordance with a specific embodiment of the present invention;

FIG. 2 illustrates a system for measuring a change in strain in accordance with a further specific embodiment of the present invention;

FIGS. 3 to 8 show optical elements in accordance with embodiments of the present invention; and

FIG. 9 (a) to (c) illustrate a system for measuring a change in strain in accordance with a further specific embodiment of the present invention.

### DETAILED DESCRIPTION OF SPECIFIC EMBODIMENTS

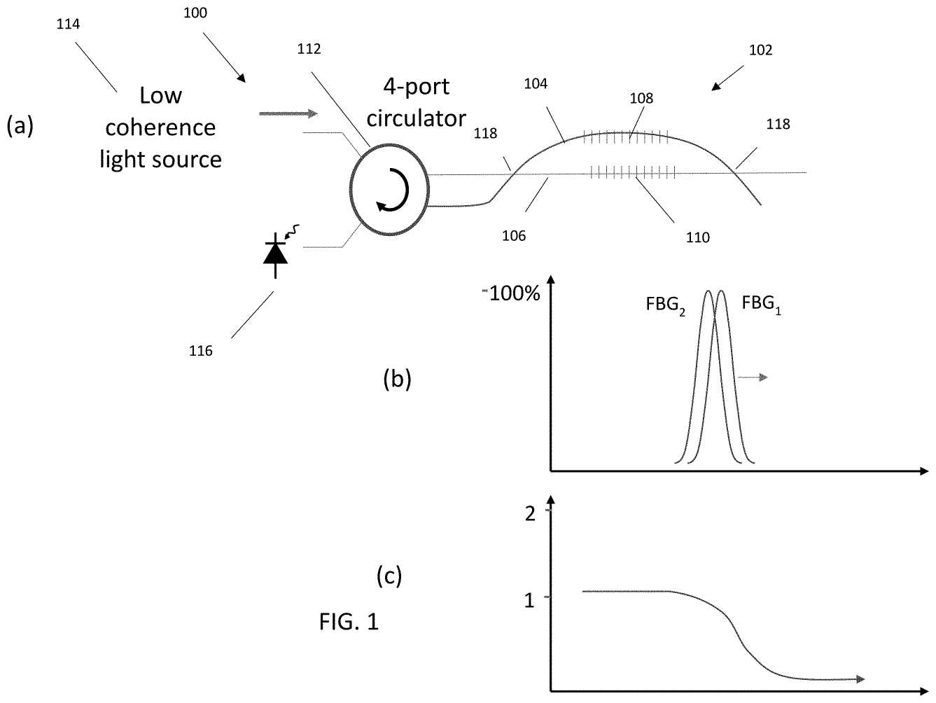

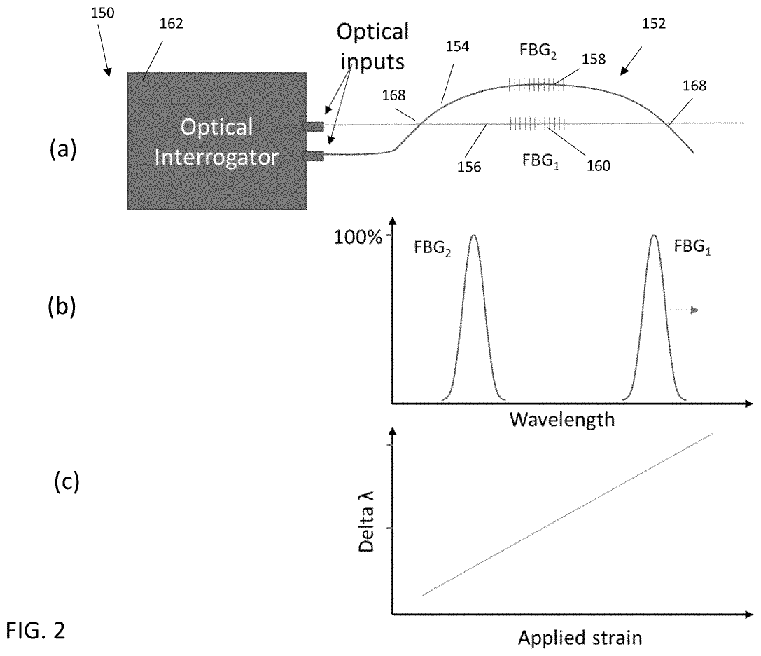

Referring initially to FIG. 1 (a) a system 100 for measuring a change in strain is now described. The system 100 comprises an optical element 102 with optical fibres 104 and 106. Each of the optical fibres 104 and 106 comprise in this embodiment one Bragg grating 108, 110, respectively, having identical optical properties. The optical fibre 106 has a nominally straight orientation while the optical fibre 104 is curved. The optical fibres 104 and 106 are attached to each other at attachment portions 118 using a suitable adhesive or mechanical fixation. The optical element 102 is arranged such that, when an axial or uniaxial strain is equally applied to ends of the optical element 102, an optical response from Bragg grating 108 of the optical fibre 104 differs from an optical response form the Bragg grating 110 of the optical fibre 106. The optical element 102 will be described in detail further below with reference to FIGS. 2-5.

The system 100 further comprises an optical circulator 112 which in this embodiment has 4 ports. In addition, the system 100 comprises a broadband light source 114 and a detector 116. The light source 114 is coupled to a first port of the optical circulator 112, the optical sensing element 102 is coupled to a second port and third port of the optical circulator 112 and the detector 116 is coupled to a fourth port of the optical circulator 112.

The system 100 is in this embodiment arranged such that light generated by the light source 114 and directed into optical fibre 106 of the optical element 102 by the circulator 112 and a response of the Bragg grating 110 (a reflection) is then directed by the optical circulator 112 into the optical fibre 104 with the Bragg grating 108. When no axial or uniaxial strain is applied the optical element 102, the Bragg grating 110 of the optical fibre 106 will generate an optical response (reflect light) at a specific wavelength and that response will be reflected by the Bragg grating 108 of the optical fibre 104 and that response will then be detectable by the detector 116. Alternatively, when an axial or uniaxial strain is applied to the optical element 102, the Bragg grating 108 generates an optical response (reflect light) at a specific wavelength and the Bragg grating 110 of the second optical fibre 106 will also generate a response, but at a (slightly) different wavelength and consequently will only reflect a portion of the response form the Bragg grating 110. The change in applied strain consequently is detectable by the detector 116 as a change in total light intensity (a change in intensity with a change in applied strain). The graph shown in FIG. 1 (b) schematically illustrates the slightly different responses of the Bragg grating 108 (FBG1) and the Bragg grating 110 (FBG2) and the graph shown in FIG. 1 (c) schematically illustrates a light intensity as detectable by the detector 116 and as a function of applied strain. If the Bragg grating 110 has a nominal response (no strain applied) at a wavelength that is at a slightly higher wavelength than the nominal response of the Bragg grating 108, the light intensity detectable by the detector 116 decreases (less overlap between the responses) with an increase in applied strain. Alternatively, if the Bragg grating 110 has a nominal response (no strain applied) at a wavelength that this is slightly lower than the nominal response by the Bragg grating 108 the light intensity detectable by the detector 116 increases (more overlap between the responses) with an increase in applied strain.

FIG. 2 shows an optical system 150 in accordance with another embodiment of the present invention. The system 150 comprises an optical element 152 which is related to the optical element 102 discussed above with reference to FIG. 1. The optical element 152 comprises optical fibres 154 and 156 each comprising in this embodiment one Bragg grating 158, 160, respectively. The optical fibre 156 has a nominally straight orientation while the optical fibre 154 is curved. The optical fibres 154 and 156 are attached to each other at attachment portions 168 using a suitable adhesive or mechanical fixation. The optical element 152 is arranged such that, when an axial or uniaxial strain is equally applied to ends of the optical element 152, an optical response from Bragg grating 158 of the optical fibre 154 differs from an optical response form the Bragg grating 160 of the optical fibre 156.

The system 150 comprises in this embodiment an optical interrogator 162 to which the optical fibres 154 and 156 are coupled. The system 150 is arranged such that light generated by the optical interrogator 162 and is directed into optical fibres 154, 156. Response of the Bragg gratings 158, 160 (reflections) are then detected by the optical interrogator 112. When no axial or uniaxial strain is applied the optical element 152, the Bragg grating 160 of the optical fibre 156 will generate specific optical responses (reflect light) at specific wavelengths. Alternatively, when an axial or uniaxial strain is applied to the optical element 152, the Bragg grating 160 will have a response at a slightly shifted wavelength, while the Bragg grating 158 will have a response that is not or less shifted than the response of the Bragg grating 160. The change in applied strain consequently is detectable by the optical interrogator 162. The graph shown in FIG. 2 (b) schematically illustrates a change in wavelength separation of the responses of the Bragg gratings as a function of applied strain (in this example the Bragg grating 160 has a response equal to or at a higher wavelength than the Bragg grating 156; the wavelength separation would decease with applied strain for the inverse case).

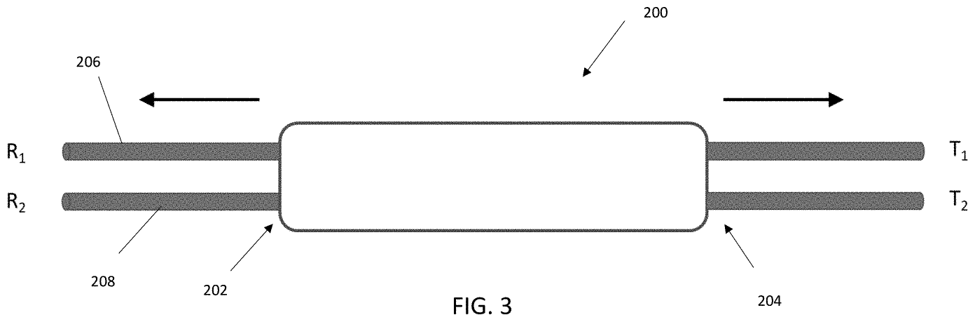

Turning now to FIG. 3, an optical element 200 for measuring a change in strain in accordance with an embodiment of the present invention is now described. The optical element 200 has ends 202 and 204 and optical fibres 206 and 208, which are mechanically coupled to each other. Each of optical fibre 206 and 208 has a Bragg grating (not shown) between the ends 202 and 204. The optical element is arranged such that, when an axial or uniaxial strain is equally applied to optical fibres 206 and 208 at the ends of the optical element 200, an optical response from the Bragg grating of optical fibre 206 differs from an optical response form the Bragg grating of the optical fibre 208. The optical response from the Bragg gratings 206, 208 may be detected in reflection or in transmission. The optical element 200 may for example replace the optical element 102 shown in FIG. 1. However, if both optical fibres are exposed to a change in ambient temperature, the Bragg gratings of the optical fibres 206, 208 will experience the approximately the same change in refractive index and consequently a change in ambient temperature will have no or only a minimal influence on the difference between the optical responses of the Bragg gratings in the optical fibres 206, 208.

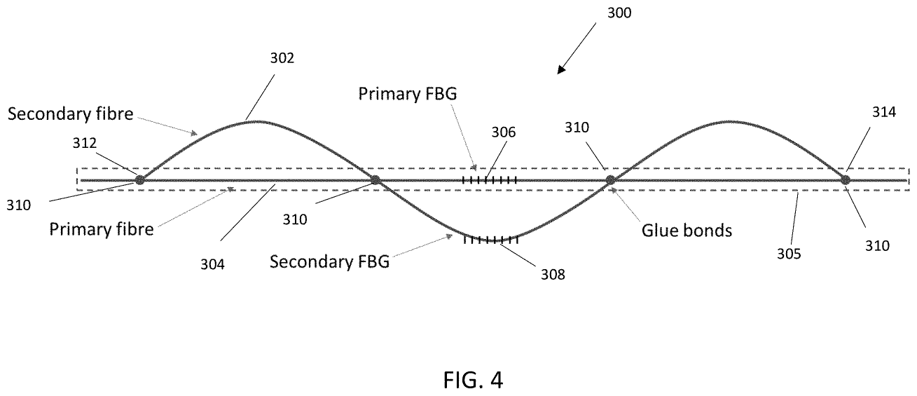

Variations of the optical element in accordance with embodiments of the present invention will now be described in further detail. FIG. 4 shows an optical element 300 having optical fibres 302 and 304. The optical fibres 302, 304 each comprise a Bragg grating 306 and 308, respectively. In this embodiment the optical fibres 302, 304 and also the Bragg gratings 306, 308 have different geometrical arrangements. The optical fibre 302 has a nominally straight orientation and the optical fibre 304 has an undulating (in this embodiment sinusoidal) shape in a plane. The optical fibres 302 and 304 are rigidly attached to each other at attachment points 310 using a suitable adhesive or mechanical fixation.

In this embodiment the optical fibre 304 is attached to an object (not shown) along the entire length between ends of the optical element 300 using an epoxy 305. It will be appreciated by a person skilled in the art that alternatively the optical fibre 304 may be attached along only a portion of the length to the object or for example only at ends of the optical element 300. Further, the optical fibre 304 may be mechanically coupled to the object using means other than the epoxy 305. In this embodiment the optical fibre 302 is attached to the optical fibre 304 at attachment points 310 only and is not otherwise attached to the optical fibre 304 or the object.

When an axial or uniaxial strain is applied to the optical element 300 for example between portions 312 and 314, the Bragg grating 306 (positioned within the optical fibre 304 attached to the object) will experience the strain, while the Bragg grating 308 (positioned within the optical fibre 302 and attached to the optical fibre 306 at attachment points 310, but not otherwise attached to the optical fibre 304 or the object) will at least in a first approximation not experience the axial or uniaxial strain or at least a much smaller strain than the Bragg grating 306, which is a consequence of the different geometrical arrangement of the optical fibres 302 and 304. However, both Bragg gratings 306, 308 will experience the same change in refractive index when exposed to the same change in ambient temperature. The optical element 300 is consequently arranged such that a difference in optical response between the Bragg gratings 306 and 308 is largely independent from a change in the ambient temperature and it is possible to determine an applied strain in a manner that is corrected for a change in ambient temperature.

In a variation of the embodiment illustrated in FIG. 4 the optical element 300 may for example comprise optical fibres that have the same geometrical arrangement (for example, both nominally straight oriented and mechanically coupled to each other), but have different materials properties such as respective stress-optic coefficients whereby an applied strain has more of an effect on the Bragg grating in one of the optical fibres than by the Bragg grating in the other one of the optical fibres. Assuming that both Bragg gratings experience nominally the same change in refractive index with a change in ambient temperature, it is again possible to determine an applied strain in a manner that is substantially corrected for an impact of a change in ambient temperature.

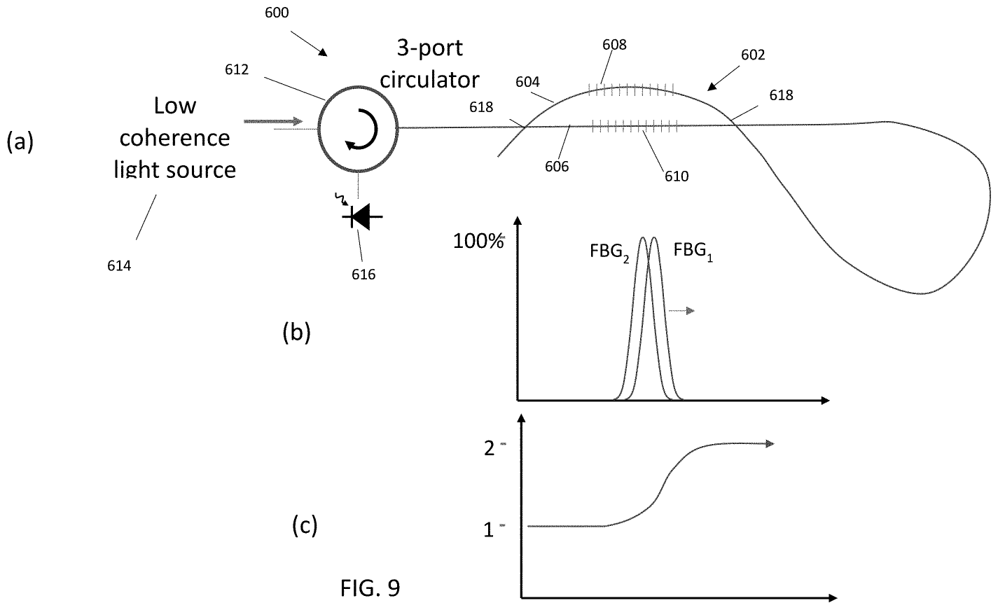

In further variations of the embodiment illustrated in FIG. 4 the optical fibres 302 and 304 may each comprise a series of Bragg gratings. Further, the optical fibres 302 and 304 may be portions of a single (looped) optical fibre, similar to the optical fibre in the optical element 602 illustrated below with reference to FIG. 9.

Further, it will be appreciated by a person skilled in the art that in variations of the described embodiment the optical fibre portions may have any other suitable geometrical arrangement. For example, both the optical fibre 304 and the optical fibre 302 may be curved with of the optical fibres having a different curvature compared to the other one of the optical fibres.

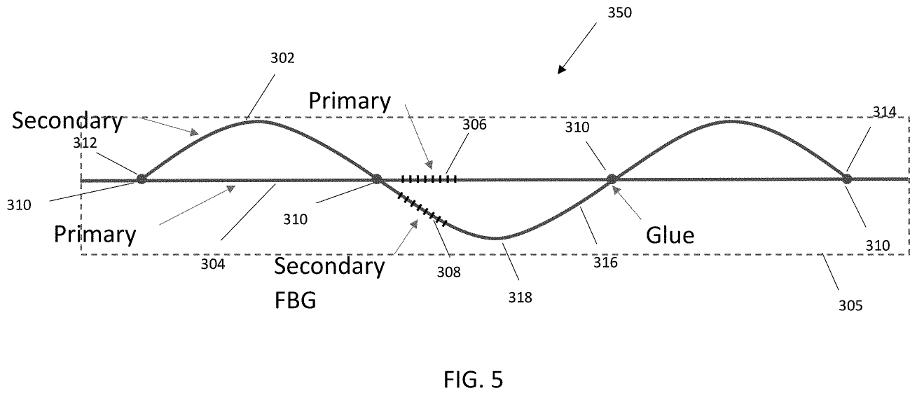

FIG. 5 illustrates a further embodiment of the optical element. FIG. 5 shows an optical element 350 which is related to the optical element 300 illustrated with reference to FIG. 4 and like features are given like reference numerals. However, in contrast to the embodiment optical element 300, the optical fibres 302 and 304 of the optical element 350 are both attached to an object using an epoxy 305. In a variation of the described embodiment the optical fibres 302 and 304 may alternatively be attached along only a portion of the length to the object. Further, the optical fibres 302 and 304 may be mechanically coupled to the object using means other than the epoxy 305. The optical fibre 304 is in this example oriented along an axis of the optical element 350 whereas the optical fibre 302 is curved and forms an undulated path around the axis of the optical element 350. The Bragg grating 306, positioned in the optical fibre 304, is also oriented along the axis of the optical element, whereas the position of the Bragg grating 308 is chosen such that the Bragg grating 308 has a transversal orientation relative to the axis of the optical element 350. As the Bragg grating 308 has a transversal orientation and the Bragg grating 306 is oriented along the axis of the optical element 350, the Bragg grating 308 will experience less strain than the Bragg grating 306 when an axial or uniaxial strain is applied to the optical element. As a consequence, an optical response from the Bragg grating 306 will differ from an optical response of the Bragg grating 308 even if both the optical fibre 302 and the optical fibre 304 are mechanically coupled to the object along the entire length of the optical element (for example using the epoxy 305) with the difference increasing with increasing angle at which the Bragg grating 308 is oriented relative to the axis of the optical element (or relative to the orientation of the Bragg grating 306).

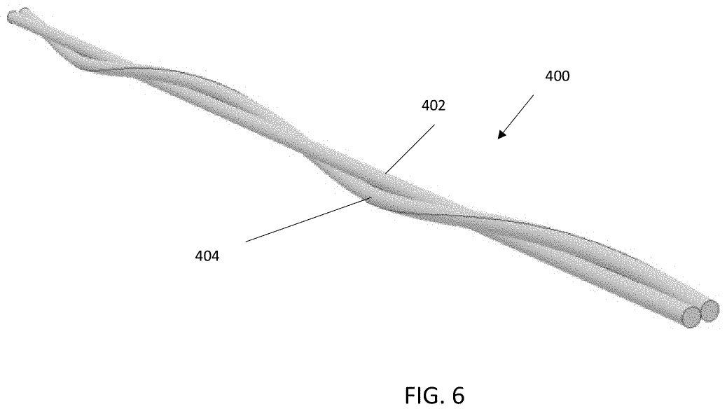

FIG. 6 shows an optical element 400 in accordance with another embodiment of the present invention. The optical element 400 comprises a first optical fibre 402, which is nominally straight and a second optical fibre 404, which is wound around the optical fibre 402 in a helical manner. Both optical fibres are attached to each other using a suitable adhesive similar to the optical element 300 described above with reference to FIG. 3. In an alternative embodiment the optical fibres 402 and 404 are attached to each other only at ends of the optical element.

The optical fibres 402, 404 each comprise one or more Bragg gratings (not shown). When an axial strain is applied to the optical element 400 between ends of the optical element 400, the one or more Bragg gratings of the optical fibre 402 will experience the axial strain, while the one or more Bragg gratings of the optical fibre 308 will experience a different (smaller) amount of axial strain, which is a consequence of the different geometrical arrangement of the optical fibres 402 and 404. However, all Bragg gratings will experience the same change in refractive index when exposed to the same change in ambient temperature. The optical element 400 is consequently arranged such that a difference in optical response between the Bragg gratings of the optical fibres 402 and 404 is at least largely independent from a change in the ambient temperature or a change in ambient temperature and it is possible to determine an applied strain in a manner that is corrected for an impact of a change in ambient temperature.

Again, it will be appreciated by a person skilled in the art that in variations of the described embodiment the optical fibre portions may have any other suitable geometrical arrangement. For example, the optical fibre 402 may not necessarily be nominally straight or the optical element may consist of an asymmetric double helix.

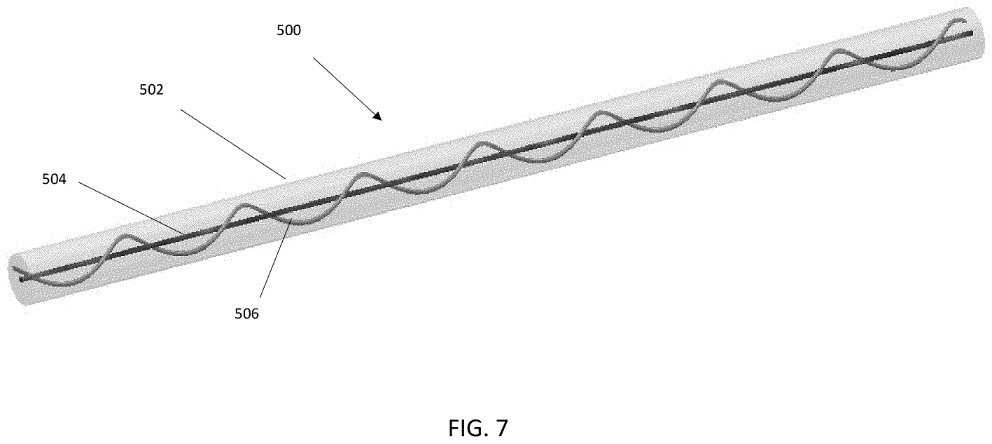

Referring now to FIG. 7, an optical element 500 in accordance with another embodiment of the present invention is now described. The optical element 500 comprises a multi-core optical fibre 502, which has a first core 504 and a second core 506. In this example the first core 504 is nominally straight and a second core 506 is would around the first core 504 in a helical manner. The cores 504 and 506 each comprise one or more Bragg gratings (not shown).

When an axial strain is applied to the optical element 500 between ends of the optical element 500, the one or more Bragg gratings of the core 504 will experience the axial strain and the one or more Bragg gratings of the core 506 will experience a different amount of axial strain, which is a consequence of the different geometrical arrangement of the cores 504 and 506. However, the Bragg gratings of each core 504, 506 will experience the same change in refractive index when exposed to the same change in ambient temperature. The optical element 500 is consequently again arranged such that a difference in optical response between the Bragg gratings of the cores 504 and 506 is largely independent from a change in the ambient temperature, with the additional advantage of the two cores being in closer thermal proximity to each other, hence providing enhanced temperature compensation.

A person skilled in the art will appreciate that various different geometrical arrangements of the cores are possible. Further, the multi-core optical fibre may comprise more than two cores.

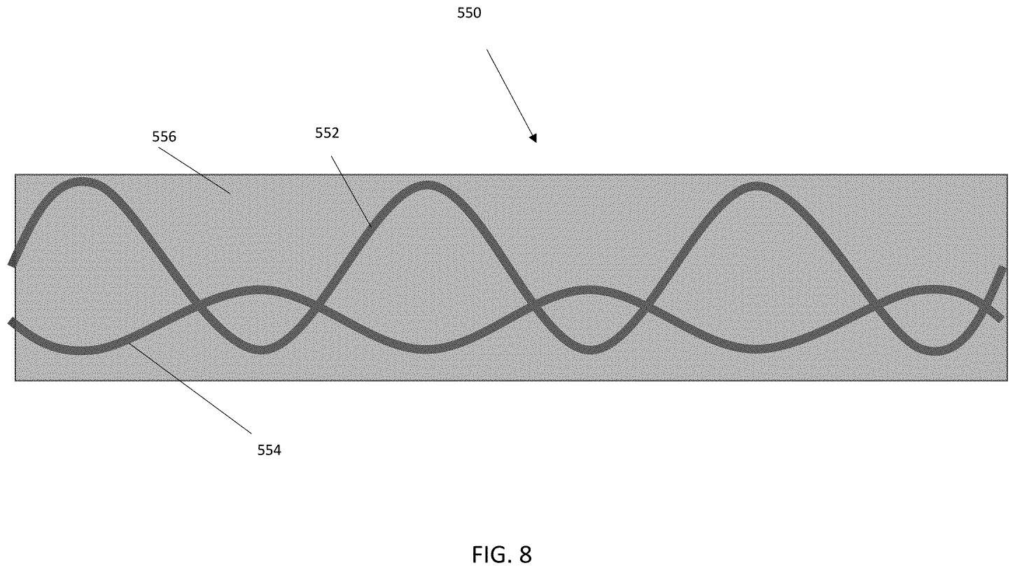

FIG. 8 shows an optical element 550 in accordance with a further embodiment of the present invention. The optical element 550 comprises optical fibres 552,554. In this example both the optical fibre 552 and the optical fibre 554 are arranged along undulating paths and indirectly coupled to each other along the entire length of the optical element 550 using an elastic material 556 (such as an elastic strip). Both optical fibres have Bragg gratings (not shown). The optical fibre 554 is less curved than the optical fibre 556. When an axial strain is applied to the optical element 550 between ends of the optical element 550, the Bragg gratings of the optical fibre 554 will experience the axial strain and Bragg gratings of the core 556 will experience a larger amount of axial strain, which is a consequence of the different geometrical arrangement of the optical fibres 554 and 556. However, the Bragg gratings of each core 554, 556 will experience the same change in refractive index when exposed to the same change in ambient temperature. Similar to the optical element 500 described above and illustrated with reference to FIG. 7, the optical element 550 is consequently again arranged such that a difference in optical response between the Bragg gratings of the optical fibres 554 and 556 is largely independent from a change in the ambient temperature.

The optical element 550 is particularly suitable for detecting relatively large applied axial strain due to the curved arrangement of both optical fibres coupled by the elastic material 556. However, it will be appreciated by a person skilled in the art that in an alternative embodiment the optical fibre 554 may have a nominal straight orientation. Further, the optical fibres 552 and 554 may have any other suitable geometrical arrangement as long as one of the optical fibres is less curved oriented than the other optical fibre. In addition, the optical fibres may or may not be coupled to each other by the elastic material 556 along the entire length of the optical element 550. The elastic material may be provided in any suitable format and the optical fibres may for example be embedded into the elastic material. The elastic material may for example be provided in the form of an adhesive tape into which the optical fibres are embedded or to which the optical fibres are applied and which may be applied to an object.

Referring now to FIG. 9 (a) a system for measuring a change in strain is now described. The system 600 is a variation of the system 100 described above with reference to FIG. 1. The system 600 comprises an optical element 602 with optical fibre portions 604 and 606, which are portions of the same (looped) optical fibre. The optical fibre portions 604 and 606 comprise in this embodiment Bragg gratings 608, 610 having identical optical properties. The optical fibre portions 604 and 606 are attached to each other at attachment portions 618 using a suitable adhesive or mechanical fixation. The optical element 602 is arranged such that, when an axial or uniaxial strain is equally applied to ends of the optical element 602, a corresponding optical response from Bragg grating 608 differs from a corresponding optical response form the Bragg grating 610, which is in this embodiment a consequence of differences in the geometrical arrangement between the optical fibre portions 606 and 608.

The system 600 further comprises an optical circulator 612 which in this embodiment has 3 ports. In addition, the system 600 comprises a low coherence broadband light source 614 and a detector 616. The light source 614 is coupled to a first port of the optical circulator 612, the optical element 602 is coupled to a second port of the optical circulator 612 and the detector 616 is coupled to a third port of the optical circulator 612.

The optical sensing element 602 is in this embodiment arranged such that light generated by the light source 614 and directed into the optical element 602 by the circulator 612 propagates initially through the optical fibre portion 604 before reaching the second optical fibre portion 606. When no axial or uniaxial strain is applied to the optical element 602, the Bragg grating 610 of the first optical fibre portion 606 will generate an optical response (reflect light) at a specific wavelength of light and the Bragg grating 608 of the second optical fibre portion 604 will not generate a response at that specific wavelength (assuming that 100% of light at the specific wavelength is being reflected by the Bragg grating 610 of the first optical fibre portion 606). Alternatively, when an axial or uniaxial strain is applied the optical element 602, the Bragg grating 610 will generate an optical response at a slightly different wavelength and so Bragg grating 608 will now also generate an optical response (reflect light) at the original specific wavelength of light. Hence the total amount of light reflected by the optical element will increase. The change in applied strain consequently is detectable by the detector 616 as a change in total light intensity (an increase in intensity with increasing applied strain). The graph shown in FIG. 1 (b) schematically illustrates the slightly different responses of the Bragg grating 610 (FBG1) and the Bragg grating 608 (FBG2) and the graph shown in FIG. 7 (c) schematically illustrates a light intensity as detectable by the detector 616 and as a function of applied strain.

In variations of the embodiments of the systems for measuring a change in strain 100, 600 illustrated with reference to FIGS. 1 and 9, respectively, the Bragg gratings 108, 110, 608 and 610 may each be replaced by a series of Bragg gratings, such as identical series of Bragg gratings. A resultant combined response signal is then a sequence of the response signals from a first series of Bragg gratings overlapped with response signals from corresponding Bragg gratings of a second series of Bragg gratings in each system. The combined response signal is then a multiplexed signal and the detectors 116, 616 are replaced with a detector system allowing optical demultiplexing. Such a system allows the detection of a distribution of strain as experienced by Bragg gratings at the respective positions within each series, which again can be corrected for an influence of a change in ambient temperature as in each system the response from one series of Bragg gratings differs from the response of the other series of Bragg gratings, but the Bragg gratings experience the same nominal change in refractive index in response to a change in ambient temperature.

Although the invention has been described with reference to particular examples, it will be appreciated by those skilled in the art that the invention may be embodied in many other forms.

1. An optical element for measuring a change in strain, the optical element having ends and having first and second optical fiber portions for guiding light, the first and second optical fiber portions extending between the ends of the optical element and being mechanically coupled to each other at at least one position, each of the first and second optical fiber portions comprising at least one Bragg grating,
wherein the optical element is arranged such that, when an axial or uniaxial strain is equally applied to the first and second optical fiber portions at the ends of the optical element, an optical response from the at least one Bragg grating of the first fiber portion differs from an optical response form the at least one Bragg grating of the second optical fiber portion.

2. The optical element of claim 1 wherein the optical element is arranged such that a difference in optical response between the Bragg gratings of the first optical fiber portion and the second optical fiber portion is at least largely independent from a change in the ambient temperature.

3. The optical element of claim 1 wherein the first and second portions for guiding light are directly or indirectly mechanically coupled to each other at one or more positions along a length between the ends of the optical element.

4. The optical element of claim 1 wherein the first and second portions for guiding light are directly or indirectly mechanically coupled to each other at the ends of the optical element only.

5. The optical element of claim 1 wherein the first and/or second portions for guiding light are indirectly coupled along some, the majority or the entire length of the optical element using an elastic material.

6. The optical element of claim 1 wherein the optical element is structured such that a change in axial or uniaxial strain to which the optical element is exposed is experienced by the first portion for light guiding but is not experienced, or to a lesser degree experienced, by the second portion for light guiding.

7. (canceled)

8. (canceled)

9. The optical element of claim 1 wherein the first and second portions are portions of respective optical fibers.

10. The optical element of claim 1 wherein the first and second optical fiber portions have different materials properties or wherein the first and second optical fiber portions have different geometrical arrangements.

11. (canceled)

12. The optical element of claim 10 wherein the difference in optical response between the Bragg gratings of the first and second portions for guiding light is influenced by differences in materials properties such as differences in refractive indices, stress-optic coefficient, elasticities or plasticities of at least portions of the first and second portions for guiding light.

13. The optical element of claim 12 wherein the first and second portions for guiding light are positioned to guide light along paths having respective shapes.

14. The optical element of claim 13 wherein the second optical fiber portion forms an undulating shape in a plane and wherein the first and second optical fiber portions are attached to each other at various positions.

15. The optical element of claim 1 wherein the first optical fiber portion is directly or indirectly mechanically coupled to an object.

16. The optical element of claim 15 wherein the first optical fiber portion is mechanically coupled to the object along at least a majority of a length of the first optical fiber portion between the ends of the optical element.

17. (canceled)

18. (canceled)

19. The optical element of claim 1 wherein the at least one Bragg grating of the first portion for guiding light and the at least one Bragg grating of the second portion for guiding light have respective angular orientations relative to an axis of the optical element.

20. The optical element of claim 19 wherein the at least one Bragg grating of the first portion for guiding light is orientated substantially parallel to an axis of the optical element and the at least one Bragg grating of the second portion for guiding light is oriented at a transversal orientation relative to the axis of the optical element.

21. The optical element of claim 1 wherein the first optical fiber portion are oriented along an axis of the optical element and the second optical fiber portion is wound around the first optical fiber portion such as in a substantially helical manner and wherein the first and second optical fiber portions are attached to each other at various positions.

22-26. (canceled)

27. The optical element of claim 1 wherein each of the first and second portions for guiding light comprises a series of Bragg gratings.

28. A system for measuring a change in strain, the system comprising:
the optical element in accordance with claim 1;
an optical circulator having at least three ports;
a light source optically coupled to a first port of the optical circulator;
the first optical fiber portion of the optical element being optically coupled to a second port of the optical circulator and the first and second optical fiber portion being optically coupled in series; and
a detector being optically coupled to a third port of the optical circulator;
wherein the first and second portions are portions of a single optical fiber that is coupled at one end to the optical circulator and forms a loop such that both the first and second portions for guiding light are positioned in close proximity to each other.

29. A system for measuring a change in strain, the system comprising:
the optical element in accordance with claim 1;
an optical circulator having at least four ports;
a light source optically coupled to a first port of the optical circulator;
the first optical fiber portion of the optical element being optically coupled to a second port of the optical circulator;
the second optical fiber portion of the optical element being optically coupled to a third port of the optical circulator; and
a detector being optically coupled to the fourth port of the optical circulator;
wherein the first and second portions for guiding light are portions respective optical fibers.

30. A system for measuring a change in strain, the system comprising:
the optical element in accordance with claim 1;
an optical spectral interrogator, comprising a light source, a detector or detectors, and at least one independent optical input;
the first optical fiber portion of the optical element being optically coupled to one input port of the optical interrogator;
the second optical fiber portion of the optical element being optically coupled to a second input port of the optical interrogator;
wherein the first and second portions for guiding light are portions of the respective optical fibers.
